(19) United States
(12) Patent Application Publication
(10) Pub. No.: US 2018/0052805 A1
(43) Pub. Date: Feb. 22, 2018

(54) MICROCONTROLLER WITH A DIAGNOSIS MODULE AND METHOD FOR ACCESSING SAID MODULE OF SAID MICROCONTROLLER

(71) Applicants: CONTINENTAL AUTOMOTIVE FRANCE, Toulouse (FR); CONTINENTAL AUTOMOTIVE GMBH, Hannover (DE)

(72) Inventors: Bertrand DANET, Toulouse (FR); Nathalie COMBET, Cugnaux (FR); Bernhard BIEG, Regensburg (DE)

(21) Appl. No.: 15/555,271

(22) PCT Filed: Mar. 2, 2016
(86) PCT No.: PCT/EP2016/000359

§ 371 Date: Sep. 1, 2017

(30) Foreign Application Priority Data
Mar. 4, 2015 (FR) 1551794

(51) Int. Cl. G06F 15/78; G06F 11/07; G06F 13/40; G06F 11/27

(52) U.S. Cl. CPC G06F 15/7842; G06F 15/7814; G06F 11/27; G06F 13/4072; G06F 11/0739

(57) ABSTRACT

Disclosed is a method for accessing at least one diagnostic module of a microcontroller of a vehicle including an internal combustion engine, the microcontroller furthermore including an input/output bus, an interface module coupled to the input/output bus and a microprocessor. The method includes: a) reading of at least one data frame; b) reading of a target memory identification address; c) reading of the reference identification data contained in the memory; d) comparison of the reference identification data read with the identification data contained in the data frame.

The present invention relates to a method for accessing a diagnostic module of a microcontroller and an associated microcontroller.

Currently, a great many electronic systems integrate a processor within a closed housing. A connector is provided to serve as the interface between the electronic means inside of the housing and the outside. When a problem occurs in the electronic housing, the use of a diagnostic tool is generally provided which is plugged into the connector allowing access to certain software functions integrated into the processor. Most of the time, it is thus possible to reprogram the software of the electronic housing or to perform a diagnostic in order to at least discover the origin of the problem, and sometimes also to solve it. On the other hand, for certain problems, these tools do not work and, as a last resort, it may be necessary to intervene directly inside the housing in order to, on the one hand, diagnose problems and, on the other hand, solve them if possible.

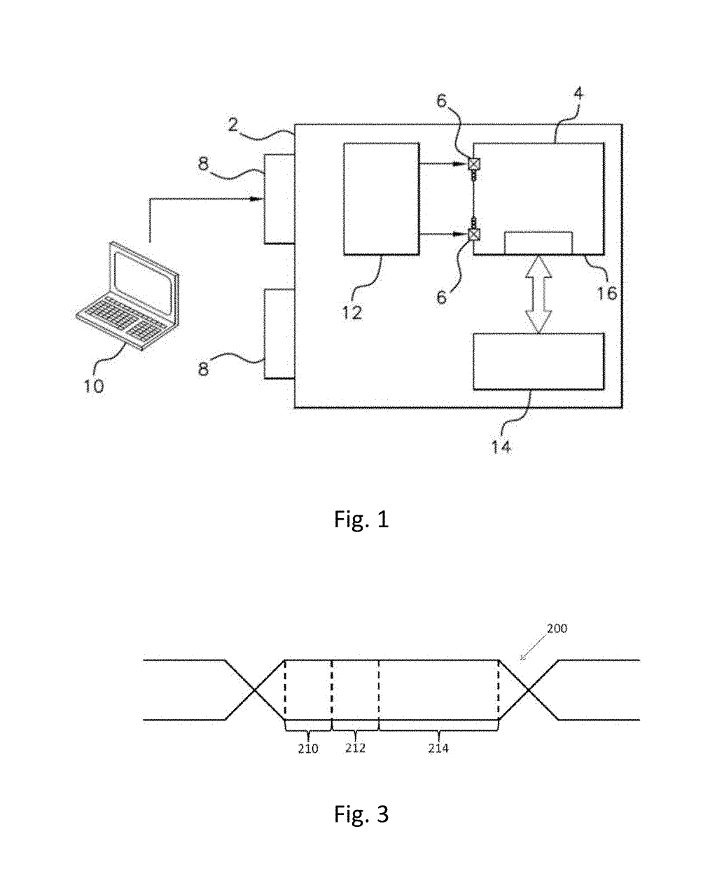

The attached FIG. 1 illustrates a processor of the prior art. This may be an engine processor for an automobile vehicle but also any electronic system within a closed housing (whether this be an industrial processor or a mass consumer product such as a toy, a telephone, etc.).

A housing 2 has been schematically represented in FIG. 1 by a rectangle. A microcontroller 4 is located inside of the latter which integrates, for example on the same chip, a microprocessor, some memory and an input/output bus 6. In the embodiment illustrated, the housing 2 has two connectors 8 which form an electrical interface between the inside and the outside of the housing 2 and allow the exchange of data in the two outside and inside directions.

FIG. 1 represents the elements implemented when a problem occurs and an intervention is carried out on the electronic device to diagnose the problem and attempt to remedy it with an external diagnostic tool 10 plugged into a connector 8. When the external diagnostic tool 10 sends a signal on the pin or pins provided for this purpose, a diagnostic procedure is started in the microcontroller 4. The signal sent by the external diagnostic tool 10 is detected by a detection circuit 12 and transmitted via the input/output bus 6 to the microcontroller 4.

Thus, if the external diagnostic tool 10 sends the ad hoc signal over the pin or pins of the connector 8, then the information is sent via the detection circuit 12 to the microcontroller 4 which automatically goes into diagnostic mode. In this mode, the microcontroller 4 waits for example for a software application to be loaded and executes it after loading. A communication can thus be established between the microcontroller 4 and the external diagnostic tool 10 in order, amongst other things, to carry out an update.

However, in certain situations, depending on the problem encountered, it is not possible to carry out a diagnosis with the external diagnostic tool 10 and it is necessary to open the housing 2. For this purpose, a debugging connector 14 is then provided in order to access the microcontroller 4 via a debugging port 16 of the microcontroller 4.

The drawbacks of the structure described hereinabove (and illustrated in FIG. 1) are in particular that it is required to make provision for at least one pin on an external connector 8 of the electronic system, a detection circuit 12 and at least one input at the level of the input/output bus 6 to activate the diagnostic mode. Furthermore, even if the access via the pin of the connector is not intended to be wired in a standard product, it constitutes a security flaw of the electronic system.

Furthermore, if access to the debugging connector 14 inside of the housing 2 is necessary, the housing 2 has to be opened and, in virtually all cases, this is sealed precisely in order to avoid it being opened. This procedure accordingly then renders the housing 2 unusable and it has to be changed.

The aim of the present invention is accordingly to provide a method for accessing a diagnostic module and/or method of intervention for an electronic system which does not require the assignment of at least one specific pin for the configuration of the microcontroller (pin notably allowing the diagnostic mode to be engaged) and a corresponding electronic system. Advantageously, this method for accessing the diagnostic module will also obviate the need to open the housing of the electronic system, even in the case of a serious problem.

Preferably, the security of the electronic system provided will be enhanced.

Advantageously, the implementation of the invention on a consumer electronic system will not lead to an increase in the cost of production of this product.

For this purpose, the present invention proposes a method for accessing at least one diagnostic module of a microcontroller of a vehicle comprising an internal combustion engine, the method comprises the following steps:

a) reading of at least one data frame originating from the interface module,

b) reading of a target memory identification address contained in the data frame,

c) reading of the reference identification data contained in the memory at the target memory identification address,

d) comparison of the reference identification data read with the target memory identification data contained in the data frame,

e) as a function of the result of the comparison:
sending of the complete data frame to the microprocessor when the reference identification data are different from the target memory identification data,
sending of the data to be executed contained in the data frame to the diagnostic module when the reference identification data are identical to the target memory identification data.

As a variant of this method, a method is provided for accessing a diagnostic module of a microcontroller in which the microcontroller comprises several diagnostic modules. The method variant repeats steps a), b), c) and d) hereinabove and in step e), the following three options are provided:
e1) sending of the complete data frame to the microprocessor when the reference identification data are different from the target memory identification data,
e2) sending of the data to be executed contained in the data frame to the diagnostic module when the reference identification data are identical to the target memory identification data and they signify the diagnostic module,
e3) sending of the data to be executed contained in the data frame to the other diagnostic module when the reference identification data are identical to the target memory identification data and they signify a second diagnostic module.

A variant of these methods simultaneously provides in steps a), b), c), d), and e) a step or function for emulating a watchdog. This emulation advantageously makes it possible to render transparent a mode of debugging or of reprogramming of the microcontroller for other electronic circuits coupled to the microcontroller.

To place the microcontroller in a so-called debugging mode of operation, provision is made in a variant that in step e2) the microcontroller is placed in a debugging mode of operation and is managed by the diagnostic module.

To place the microcontroller in a so-called serial programming mode of operation, provision is made in another variant that in step e3) the microcontroller is placed in a serial programming mode managed by the second diagnostic module.

The present invention also proposes a microcontroller of a vehicle comprising an internal combustion engine, the microcontroller with a diagnostic module, an input/output bus, an interface module coupled to the input/output bus and a microprocessor.

According to the present invention, the microcontroller furthermore comprises means for reading and analyzing at least one data frame originating from the interface module, means for reading a target memory identification address contained in the data frame, means for reading reference identification data in the memory, means for comparing the reference identification data with the identification data contained in the data frame, means for sending the data frame to the microprocessor or to the diagnostic module.

This structure makes it possible to create a link authorizing access to one or more diagnostic modules by virtue of the presence of the router module, associated with a memory. It accordingly becomes unnecessary to open the housing in which the microcontroller is located in order to gain access to the diagnostic module via its connector which can become optional with such an architecture.

The interface module of such a microcontroller operates for example according to the CAN protocol (acronym for “Controller Area Network”). Other protocols (Ethernet, Flexray, etc.) may also be envisioned.

In order to be compatible with the communication standards used for example in the automobile sector, provision is made, in variant embodiments, that decoding module is compatible with a CAN protocol and/or compatible with a serial programming protocol.

So as not to interrupt the operation of the processor during the execution of the debugging method for example, provision is made, in another variant, that the decoding module comprises means for emulating a watchdog.

To improve the security of such a processor, provision is made in an exemplary embodiment to use a flash memory in the microcontroller.

A variant embodiment provides for example that the microcontroller such as described above furthermore comprises a debugging port associated with a diagnostic module. This debugging port is of course optional since it is possible to access the diagnostic module via another channel.

The present invention also relates to a processor designed for an automobile vehicle and comprising a microcontroller such as described hereinabove.

Details and advantages of the present invention will become more clearly apparent from the description that follows, presented with reference to the appended schematic drawing in which:

FIG. 1 illustrates an electronic system integrating a microcontroller of the prior art,

FIG. 2 illustrates, in an electronic system, according to the present invention, the architecture of a microcontroller supporting diagnostic modes through a standard communication module and its secure method for activating the diagnostic modes by virtue of a router module utilizing data stored in an internal memory of the microcontroller, and

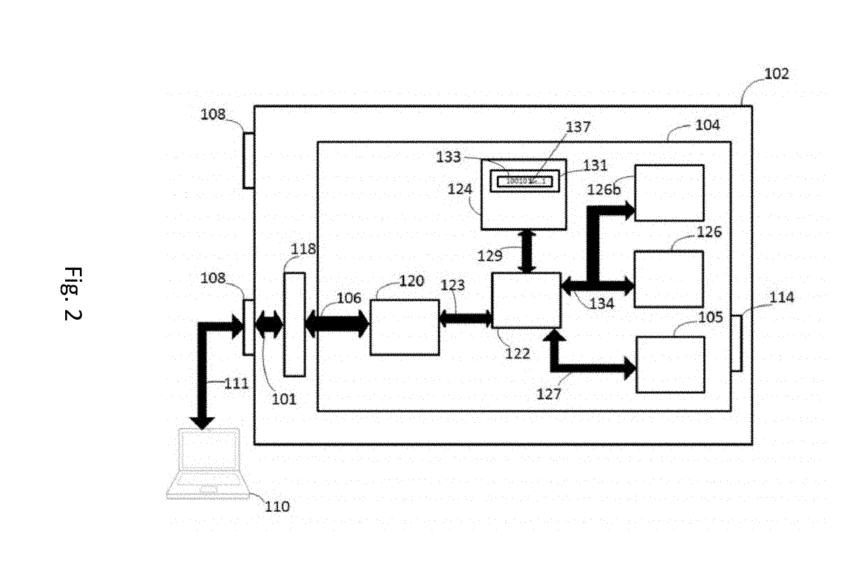

FIG. 3 schematically illustrates a data frame that can travel via and be processed by the microcontroller according to the invention.

FIG. 1 illustrating a device of the prior art has already been described in the preamble.

FIG. 2 illustrates a novel processor. It may be an engine processor for an automobile vehicle but also any electronic system in a closed housing (whether it be an industrial processor or a mass consumption product such as a toy, a telephone . . . ).

A housing 102 has been schematically represented in FIG. 2 by a rectangle. Depicted inside the latter is a microcontroller 104 which integrates, for example on one and the same chip, a microprocessor 105 and an input/output bus 106. In the embodiment illustrated, the housing 102 exhibits two connectors 108 which produce an electrical interface between the inside and the outside of the housing 102 and allow data transfer in both directions, outward and inward.

The processor described is for example a data processor operating according to the CAN protocol. Between the connector 108 and the input/output bus 106 of the microcontroller 104, a CAN interface 118 makes it possible to adapt electrical signals originating from an external bus 111 and traveling via the input/output bus 106.

The microcontroller 104 furthermore comprises an interface module 120. In the subsequent description the interface module 120 will be a CAN module 120 to ensure compatibility between the data received via the input/output bus 106 and the microprocessor 105.

In an original manner, provision is made here to station a router module 122 and a memory 124 between the CAN module 120 and the microprocessor 105. A first communication bus 123 is used to ensure data transfer between the router module 122 and the CAN module 120. This first communication bus 123 is for example a bidirectional communication bus. To access the memory 124, the router module 122 uses an identification bus 129. The identification bus 129 is for example a unidirectional communication bus. The microcontroller 105 is coupled to the router module 122 by a second communication bus 127. Preferentially, the second communication bus 127 exhibits the same technical features as the first communication bus 123.

The memory 124 is for example a memory of the flash memory type. As is represented symbolically in FIG. 2, the memory 124 exhibits at least one reference memory identification address 131 corresponding to a memory slot 133. The memory slot 133 stores reference identification data 137. The reference identification data 137 are symbolized in FIG. 2 by “0” bits and “1” bits. This representation is only illustrative and wholly non-restrictive. The storage capacity of the memory slot 133 is for example 128 bits. Of course, the storage capacity of the memory slot 133 will depend on the application and on the size of the data to be stored. Also, the memory 124 can comprise a determined number N of memory slots 133-N each exhibiting a memory identification address 131-N.

The microcontroller 104 exhibits, furthermore, a first diagnostic module 126 and one or more second diagnostic modules 126b. To ensure data transfer between the router module 122 and the diagnostic modules 126, 126b a test bus 134 is used. The diagnostic modules 126, 126b being well known to the person skilled in the art, they will not be presented in the subsequent description.

Preferentially, the router module 122 and also the memory 124 are integrated into the microcontroller 104, that is to say they are produced on the same electronic chip. Thus, the integration of the router module 122, of the memory 124 and of the dedicated buses is optimized, making it possible to control the cost of production of such a device.

The router module 122 can also be for example a decoding/routing module, that is to say that it can ensure data decoding functions and data transmission functions.

In a variant embodiment, the router module 122 exhibits emulation means making it possible to emulate a watchdog on the first communication bus 123. Thus, it is possible to simulate operation in normal mode of use of the microcontroller 104 during, for example, a phase of debugging or reprogramming of the latter.

When an engine processor of a vehicle exhibits malfunctions, it can be returned to the maker of the processor or to the maker of the vehicle in order to detect and identify the origin of said malfunction. Accordingly, it is necessary to place the engine processor in a dedicated mode allowing an approved user to access internal data of the engine processor.

In the subsequent description, a protocol or method for accessing at least one diagnostic module 126 of a microcontroller 104 installed in a vehicle processor will be presented.

The activation of a mode termed the diagnostic mode is done by sending specific data through the connector 108 via an electrical cable 111 to which a laptop computer 110 is connected (FIG. 2). The computer 110 executes a dedicated program compatible with the engine processor.

As emerges from the description given with reference to FIG. 2, at least one data frame 200 is transmitted from the computer 110 to the microcontroller 104 with the aid of the CAN interface 118. This data frame 200 travels firstly through the input/output port 106 and then through the microcontroller 104 before being formatted by the CAN module 120. The formatting of the data frame 200 by the CAN module 120 consists of the adaptation of the electrical levels of the corresponding signals to the data frame 200 so as to be compatible with the internal structure (electronic components) of the microcontroller 104.

Once the data frame 200 has been formatted, it is directed via the first communication bus 123 to the router module 122. FIG. 3 schematically presents a data frame 200 that can travel across the microcontroller 104. The data frame 200 exhibits, for example, at least one first series of bytes relating to a target memory identification address 210, a second series of bytes relating to identification data 212 and a third series of bytes relating to data to be executed 214. The speed of transmission of the data frames 200 is dependent for example on the type of bus used.

Once the data frame 200 has been received, the router module 122 decodes the first series of bytes and extracts therefrom the target memory identification address 210 and will then read at the corresponding reference memory identification address 131 (memory 124) the data contained in the memory slot 133. The router module 122 therefore recovers reference identification data 137. These data can be considered to be a password.

A comparison is thereafter carried out by the router module 122 between the data of the second series of bytes (identification data 212) and the reference identification data 137 (password) contained in the corresponding memory slot 130. As a function of the result of this comparison, actions are carried out by the router module 122.

In the case where the reference identification data 137 read are identical to the identification data 212, then the router module 122 sends only the third series of data of the data frame 200, that is to say the data to be executed 214, to a diagnostic module 216, 216b, via the test bus 134.

In the case where the identification data 212 are different from the reference identification data 137, then the data frame 200 received by the router module 122 is sent complete (first series of data, second series of data and third series of data) to the microprocessor 105 via the second communication bus 127. In this case, the router module 122 is then transparent in the sense that it allows the data identified as forming part of its basic function to pass through toward the microprocessor 105.

Thus, by virtue of the invention, it is possible to toggle a microcontroller 104 of a processor into a particular mode (not the normal mode of operation of the processor) without assigning a/several pin(s) of the input/output bus 106. Furthermore, the security of the processor is improved since no pin is left unwired or unused.

The protocol/method for accessing a diagnostic module 126, 126b presented hereinabove can be made more complicated so as to improve the security of the processor and/or as a function of the tasks to be carried out. A protocol/method for placing the microcontroller 104 in serial programming mode managed by a second diagnostic module 126b and another protocol/method for placing the microcontroller 104 in debugging mode managed by a first diagnostic module 126 will be presented in the subsequent description.

To carry out the protocols mentioned in the previous paragraph, other data or identifiers can be stored in the memory 124, such as for example (possibly non-exhaustive list):
parameters termed CAN parameters 128 related to the CAN protocol used by the microcontroller 104 as startup configuration,
parameters termed watchdog management parameters used to deactivate the watchdog or to emulate it during the activation of the diagnostic modules,
as well as passwords.

Case of implementation on a CAN bus: protocol/method for placing the microcontroller 104 in serial programming mode managed by the second diagnostic module 126b.

In this mode of operation, data frames 200, received by the router module 122, contain for example a target memory identification address 210 with values SID0, SID1, . . . SIDn. The various steps of the protocol are presented hereinbelow.

S1) the computer 110 sends a data frame 200 containing a target memory identification address 210 with the value SID0 for example, identification data 212 with the value SPWD0 for example and data to be executed 214. For this first phase, the CAN module 120 is in solely passive listening mode. The data frame 200 is decoded by the router module 122 and the target memory identification address 210 is decoded, and then the value SID0 is extracted. The router module 122 will thereafter read at the corresponding reference memory identification address, reference identification data 137 corresponding to the value SIPD0. The router module 122 thereafter compares the reference identification data 137 with the identification data 212 contained in the data frame 200. In our example, this value is SPWD0.

In the case where the identification data 212 are identical to the reference identification data 137, then we go to the following step S2 of the protocol.

In the case where the identification data 212 are different to the reference identification data 137, the microcontroller 104 remains in the state S1 and the data frame 200 is sent to the microprocessor 105 via the second communication bus 127.

No message is sent to the outside by the microcontroller 104.

S2) the computer 110 then sends a second data frame 200 containing a target memory identification address 210 with the value SID1, identification data 212 with the value SPWD1 and data to be executed 214. The data frame 200 is decoded by the router module 122 and the target memory identification address 210 is identified. The value SID1 is extracted. The router module 122 will thereafter read at the reference memory identification address 131 the reference identification data 137. The router module 122 thereafter compares the reference identification data 137 with the identification data 212 contained in the data frame 200. In our example, this value is SPWD1.

In the case where the identification data 212 are identical to the reference identification data 137, then we go to the following step S3 of the protocol. No message is sent by the microcontroller 104 to the outside and it switches to serial programming mode.

In the case where the identification data 212 are different to the reference identification data 137, then the microcontroller 104 returns to the previous state S1 and the data frame 200 is sent to the microprocessor 105 via the second communication bus 127.

Furthermore, the watchdog function of the microprocessor 105 is preferably deactivated. As a variant, it is possible to emulate the watchdog function, that is to say that a signal simulating the watchdog function is sent outside the microcontroller 104 via the first communication bus 123. By virtue of this function, it is possible to toggle the microprocessor 105 into serial programming mode while the other electronic devices are made to operate normally.

S3) series of data frames 200 are thereafter sent by the computer 110. In order to remain in this serial programming mode the data frames 200 must comprise the same identifier SID2, otherwise the protocol is stopped. The steps for reading and comparing the identification data 212 and 137 are identical to steps 1 and 2 of the previous paragraphs. Thereafter, the router module 122 sends the partial data frame 200, that is to say only the data to be executed 214 of the data frame 200, to the second diagnostic module 126b.

In a variant the entire data frame 200 is sent to the second diagnostic module 126b.

The second diagnostic module 126b responds thereafter by sending a frame containing the identifier SID3 and communication acknowledgment or control data.

This mode therefore makes it possible to program all or part of the engine processor without using a dedicated pin of the input/output bus. Moreover, the programming is thus made secure by passwords. In a substantially similar manner, it is possible also with the microcontroller 104 described above to switch to debugging mode.

In this mode of operation, the data frames 200 received by the router module 122 contain, for example, a target memory identification address 210 with values DID0, DID1, . . . DIDn. The various steps of the protocol are presented hereinbelow.

D1) the computer 110 sends a data frame 200 containing a target memory identification address 210 with the value DID0, identification data 212 with the value DPWD0 and data to be executed 214. For this first phase, the CAN module 120 is in solely passive listening mode. The data frame 200 is decoded by the router module 122 and the target memory identification address 210 is identified. The value DID0 is extracted. The router module 122 thereafter will read at the reference memory identification address 131 the reference identification data 137 corresponding to the value DIPD0. The router module 122 thereafter compares the reference identification data 137 with the identification data 212 contained in the data frame 200. In our example, this value is DPWD0.

In the case where the identification data are identical then we go to the following step D2 of the protocol.

In the case where the information is not identical, then the microcontroller 104 remains in the state D1 and the data frame 200 is sent to the microprocessor 105 via the second communication bus 127. No message is sent to the outside by the microcontroller 104.

D2) the computer 110 then sends a second data frame 200 containing a target memory identification address 210 with the value DID1, identification data 212 with the value DPWD1 and data to be executed 214. The data frame 200 is decoded by the router module 122 and the target memory identification address 210 is identified. The value DID1 is extracted. The router module 122 will thereafter read at the reference memory identification address 131 the reference identification data 137 corresponding to the value DIPD1. The router module 122 thereafter compares the reference identification data 137 with the identification data 212 contained in the data frame 200. In our example, this value is DPWD1.

In the case where the identification data 212 are identical to the reference identification data 137 then we go to the following step D3 of the protocol. No message is sent by the microcontroller 104 to the outside and it switches to serial programming mode.

In the case where the identification data 212 are different to the reference identification data 137, then the microcontroller 104 returns to the previous state D1 and the data frame 200 is sent to the microprocessor 105 via the second communication bus 127.

Furthermore, the watchdog function of the microprocessor 105 is preferably deactivated, and can also be emulated as presented above.

D3) series of data frames 200 are thereafter sent by the computer 110. To remain in this serial programming mode, the data frames 200 must comprise the same identifier DID2, otherwise the protocol is stopped. The steps for reading and comparing the identification data 212 with the reference identification data 137 are identical to steps 1 and 2. Thereafter, the router module 122 sends the partial data frame 200, that is to say only the data to be executed 214 of the data frame 200, to the diagnostic module 126.

In a variant, the entire data frame 200 is sent to the first diagnostic module 126.

The first diagnostic module 126 responds thereafter by sending a frame containing the identifier DID3 and communication acknowledgment or control data.

By virtue of the invention, it is not necessary to open the housing 102 in order to be able to communicate with the first diagnostic module 126 and/or the second diagnostic module 126b. The embodiment illustrated in FIG. 2 has made provision to preserve a debugging connector 114 but it would be possible to dispense with the latter.

On an electronic system such as described hereinabove, in which a software application is installed, if a problem occurs and the standard diagnostic services for the application corresponding to the installed software do not work, it is then no longer necessary to open the housing in order to be able to gain access via the debugging connector to the low-level diagnostic resources of the microprocessor installed in the core of the electronic system. According to the present invention, the diagnostic may be carried out through a standard serial port, without requiring a (or several) dedicated pin(s).

The security of the electronic system is accordingly enhanced because the system remains a closed system. The access to the diagnostic modules is carried out via a procedure made secure by passwords which are for example saved in memory in the microcontroller as the last step in the production line. Each product has its own passwords which are stored in the memory associated with the router module which is in a protected area of the microcontroller.

The standard product integrating the electronic system described does not exhibit any cost overhead with respect to a similar prior art system for which it is necessary to open the housing (and having done so, in the very great majority of cases rendering it unusable).

The system described above also makes it possible to have functionalities such as the management of a watchdog and the management of configuration parameters (Baud rate CAN, . . . ). It also makes it possible to emulate the watchdog function.

The exemplary embodiment includes the use of the CAN protocol which is widely used in the automobile industry. However, the present invention may also be implemented with other protocols, for example (but not limited to) CAN-FD, Ethernet, Flexray, etc. As already mentioned, the field of application is not limited to the automobile industry.

Of course, the present invention is not limited to the preferred embodiment described hereinabove and illustrated in the drawing and to the variant embodiments mentioned but extends to all variants within the scope of the person skilled in the art.

1. A method for accessing at least one diagnostic module (126) of a microcontroller (104) of a vehicle comprising an internal combustion engine, the microcontroller (104) furthermore comprising an input/output bus (106), an interface module (120) coupled to the input/output bus (106) and a microprocessor (105), wherein it comprises the following steps:
a) reading of at least one data frame (200) originating from the interface module (120),
b) reading of a target memory identification address (210) contained in the data frame (200),
c) reading of the reference memory identification data (131) contained in the memory (124) at the target memory identification address (210),
d) comparison of the reference identification data (137) read with the identification data (212) contained in the data frame (200),
e) as a function of the result of the comparison:
sending of the complete data frame (200) to the microprocessor (105) when the reference identification data (137) are different from the identification data (212),
sending of the data to be executed (214) contained in the data frame (200) to the diagnostic module (126) when the reference identification data (137) are identical to the identification data (212).

2. The method for accessing at least one diagnostic module (126) of a microcontroller (104) of a vehicle comprising a combustion engine as claimed in claim 1, in which the microcontroller (104) comprises several diagnostic modules (126, 126b), wherein in step e), the following three options are provided:
e) as a function of the result of the comparison:
e1) sending of the complete data frame (200) to the microprocessor (105) when the reference identification data (137) are different from the identification data (212),
e2) sending of the data to be executed (214) contained in the data frame (200) to the diagnostic module (126) when the reference identification data (137) are identical to the identification data (212) and they signify the diagnostic module (126),
e3) sending of the data to be executed (214) contained in the data frame (200) to the other diagnostic module (216b) when the reference identification data (137) are identical to the identification data (212) and they signify a second diagnostic module (126b).

3. The method for accessing at least one diagnostic module (126) of a microcontroller (104) of a vehicle comprising a combustion engine as claimed in claim 1, wherein the following step is carried out:
emulation of a watchdog during steps a), b), c), d) and e).

4. The method for accessing at least one diagnostic module (126) of a microcontroller (104) of a vehicle comprising a combustion engine as claimed in claim 1, in which the microcontroller (2) comprises several diagnostic modules (126, 126b), wherein in step e2) the microcontroller (105) is placed in a debugging mode of operation and is managed by the diagnostic module (126).

5. The method for accessing at least one diagnostic module (126) of a microcontroller (104) of a vehicle comprising a combustion engine as claimed in claim 1, in which the microcontroller (104) comprises several diagnostic modules (126, 126b), wherein in step e3) the microcontroller (104) is placed in a serial programming mode managed by the second diagnostic module (126b).

6. A microcontroller (104) of a vehicle comprising an internal combustion engine, the microcontroller (104) comprising a diagnostic module (126), an input/output bus (106), an interface module (120) coupled to the input/output bus (106) and a microprocessor (105), further comprising:
means for reading and analyzing at least one data frame (200) originating from the interface module (120),
means for reading a target memory identification address (210) contained in the data frame (200),
means for reading reference identification data (137) in the memory (124),
means for comparing the reference identification data (137) with the identification data (212) contained in the data frame (200),
means for sending the data frame (200) to the microprocessor (105) or to the diagnostic module (126).

6. The microcontroller (104) as claimed in claim 5, wherein the means for reading and analyzing at least one data frame (200) originating from the interface module (120), the means for reading a target memory identification address (210) contained in the data frame (200), the means for reading reference identification data (137) in the memory (124), the comparison means for comparing the reference identification data (137) with the identification data (212) contained in the data frame (200) and the means for sending the data frame (200) to the microprocessor (105) or to the diagnostic module (126) are constituent of a router module (122).

7. The microcontroller (104) as claimed in claim 5, wherein the router module (122) is compatible with a CAN protocol.

8. The microcontroller (104) as claimed in claim 5, wherein the router module (122) is compatible with a CAN serial programming protocol.

9. The microcontroller (104) as claimed in claim 7, wherein the router module (122) comprises means for emulating a watchdog.

10. The microcontroller (104) as claimed claim 5, wherein the memory (124) is a flash memory.

11. A processor for automobile vehicle, comprising a microcontroller (104) as claimed in claim 5.

12. The method for accessing at least one diagnostic module (126) of a microcontroller (104) of a vehicle comprising a combustion engine as claimed in claim 2, wherein the following step is carried out:
emulation of a watchdog during steps a), b), c), d) and e).

13. The method for accessing at least one diagnostic module (126) of a microcontroller (104) of a vehicle comprising a combustion engine as claimed in claim 2, in which the microcontroller (2) comprises several diagnostic modules (126, 126b), wherein in step e2) the microcontroller (105) is placed in a debugging mode of operation and is managed by the diagnostic module (126).

14. The method for accessing at least one diagnostic module (126) of a microcontroller (104) of a vehicle comprising a combustion engine as claimed in claim 3, in which the microcontroller (2) comprises several diagnostic modules (126, 126b), wherein in step e2) the microcontroller (105) is placed in a debugging mode of operation and is managed by the diagnostic module (126).

15. The method for accessing at least one diagnostic module (126) of a microcontroller (104) of a vehicle comprising a combustion engine as claimed in claim 2, in which the microcontroller (104) comprises several diagnostic modules (126, 126b), wherein in step e3) the microcontroller (104) is placed in a serial programming mode managed by the second diagnostic module (126b).

16. The method for accessing at least one diagnostic module (126) of a microcontroller (104) of a vehicle comprising a combustion engine as claimed in claim 3, in which the microcontroller (104) comprises several diagnostic modules (126, 126b), wherein in step e3) the microcontroller (104) is placed in a serial programming mode managed by the second diagnostic module (126b).

17. The microcontroller (104) as claimed in claim 6, wherein the router module (122) is compatible with a CAN protocol.

18. The microcontroller (104) as claimed in claim 6, wherein the router module (122) is compatible with a CAN serial programming protocol.

19. The microcontroller (104) as claimed in claim 7, wherein the router module (122) is compatible with a CAN serial programming protocol.

20. The microcontroller (104) as claimed in claim 8, wherein the router module (122) comprises means for emulating a watchdog.
